(19) United States
(12) Patent Application Publication
(10) Pub. No.: US 2025/0036402 A1
(43) Pub. Date: Jan. 30, 2025

(54) DATA LINEAGE MANAGEMENT SYSTEM

(71) Applicant: Capital One Services, LLC, McLean, VA (US)

(72) Inventor: Sridhar Reddy MEKALA, Naperville, IL (US)

(21) Appl. No.: 18/360,291

(22) Filed: Jul. 27, 2023

(51) Int. Cl. G06F 8/71

(52) U.S. Cl. CPC G06F 8/71

(57) ABSTRACT

In some implementations, a data lineage management device may identify that a source code has been uploaded to a software development hosting system. The data lineage management device may retrieve the source code from the software development hosting system. The data lineage management device may determine, using a data lineage analysis model, data lineage information associated with a dataset related to the source code, wherein the data lineage analysis model includes a machine learning model that is trained based on respective data lineage information of datasets associated with a plurality of source codes. The data lineage management device may post the data lineage information to an enterprise data management system.

### BACKGROUND

Data lineage of data includes the data's origin, processing performed on the data, where the data moves, and/or the like. Data lineage provides the ability to trace errors associated with the data, to access past versions or inputs associated with the data (e.g., for reviewing and/or analyzing the data), among other actions. Data lineage can provide an audit trail of the data. In some examples, an organization may maintain data lineage information in a centralized system, such as an enterprise data management system, a metadata repository, or a similar system. Users changing data may post the data lineage information to the centralized system. Users accessing data may view the data lineage information in the centralized system, thereby accessing information associated with an evolution of the data over time.

### SUMMARY

Some implementations described herein relate to a system for managing data lineage. The system may include one or more memories and one or more processors communicatively coupled to the one or more memories. The one or more processors may be configured to identify that a version of a source code has been uploaded to a software development hosting system device. The one or more processors may be configured to retrieve the version of the source code from the software development hosting system device. The one or more processors may be configured to determine, using a data lineage analysis model, data lineage information associated with a dataset related to the version of the source code, wherein the data lineage analysis model includes a machine learning model that is trained based on respective data lineage information of datasets associated with a plurality of source codes. The one or more processors may be configured to post the data lineage information to an enterprise data management system.

Some implementations described herein relate to a method for managing a data lineage of a dataset. The method may include identifying, by a data lineage management device, that a source code has been uploaded to a Git repository hosting service. The method may include retrieving, by the data lineage management device, the source code from the Git repository hosting service. The method may include determining, using a data lineage analysis model, data lineage information associated with a dataset related to the source code, wherein the data lineage analysis model includes a machine learning model that is trained based on respective data lineage information of datasets associated with a plurality of source codes. The method may include posting, by the data lineage management device, the data lineage information to an enterprise data management system.

Some implementations described herein relate to a non-transitory computer-readable medium that stores a set of instructions. The set of instructions, when executed by one or more processors of a data lineage management device, may cause the data lineage management device to train a machine learning model based on respective data lineage information of datasets associated with a plurality of source codes. The set of instructions, when executed by one or more processors of the data lineage management device, may cause the data lineage management device to identify that a version of a source code has been uploaded to a software development hosting system device. The set of instructions, when executed by one or more processors of the data lineage management device, may cause the data lineage management device to retrieve the version of the source code from the software development hosting system device. The set of instructions, when executed by one or more processors of the data lineage management device, may cause the data lineage management device to determine, using a data lineage analysis model, data lineage information associated with a dataset related to the version of the source code, wherein the data lineage analysis model includes the machine learning model.

### BRIEF DESCRIPTION OF THE DRAWINGS

FIG. 1 is a diagram of an example associated with identifying and recording data lineage information, in accordance with some embodiments of the present disclosure.

FIGS. 2A-2D are diagrams of an example associated with a data lineage management system, in accordance with some embodiments of the present disclosure.

FIG. 3 is a diagram illustrating an example of training and using a machine learning model in connection with data lineage management, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with data lineage management, in accordance with some embodiments of the present disclosure.

FIG. 6 is a flowchart of an example process associated with data lineage management, in accordance with some embodiments of the present disclosure.

### DETAILED DESCRIPTION

The following detailed description of example implementations refers to the accompanying drawings. The same reference numbers in different drawings may identify the same or similar elements.

Vast amounts of data may be stored electronically in data structures (e.g., databases, blockchains, log files, cookies, or the like). A device may perform multiple queries, or other information retrieval techniques, to unrelated data structures to obtain data relevant to a particular task or computational operation. Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to achieve desired computational outcomes or automation outcomes, thereby expending significant computing resources (e.g., processor resources and/or memory resources) and causing significant delays.

In addition, separate use of the data, such as individually presenting the data in a user interface for analysis by a user, may be inefficient. For example, a device may separately process and/or reformat data from different data structures to obtain information for presenting in the user interface, thereby expending significant computing resources. Furthermore, individually presenting the data may increase the size of a user interface (e.g., a web page) or utilize multiple user interfaces (e.g., multiple web pages). Navigating through a large user interface or a large number of user interfaces to find relevant information creates a poor user experience, consumes excessive computing resources that are needed for a client device to generate and display the user interface(s) and that are needed for one or more server devices to serve the user interface(s) to the client device, and consumes excessive network resources that are needed for communications between the client device and the server device.

Some implementations described herein enable integration of otherwise incompatible data from multiple unrelated data structures. In some implementations, a system may use a machine learning model to predict data lineage information. For example, the machine learning model may determine data lineage information based on data relating to a change in source code posted to a software development hosting system. Based on the data lineage information, the system may automatically update an enterprise data management system, a metadata repository, and/or a similar data management system.

In this way, the machine learning model enables the system to perform operations based on otherwise incompatible data while conserving computing resources and reducing delays that would otherwise result from separate handling of the data using complex instructions and/or repetitive processing. Moreover, an output of the machine learning model may convey data from the multiple unrelated databases in a smaller user interface or in a lesser number of user interfaces than otherwise would have been used to individually present data from the multiple unrelated databases. In this way, the use of computing resources and network resources is reduced in connection with serving, generating, and/or displaying the user interface(s).

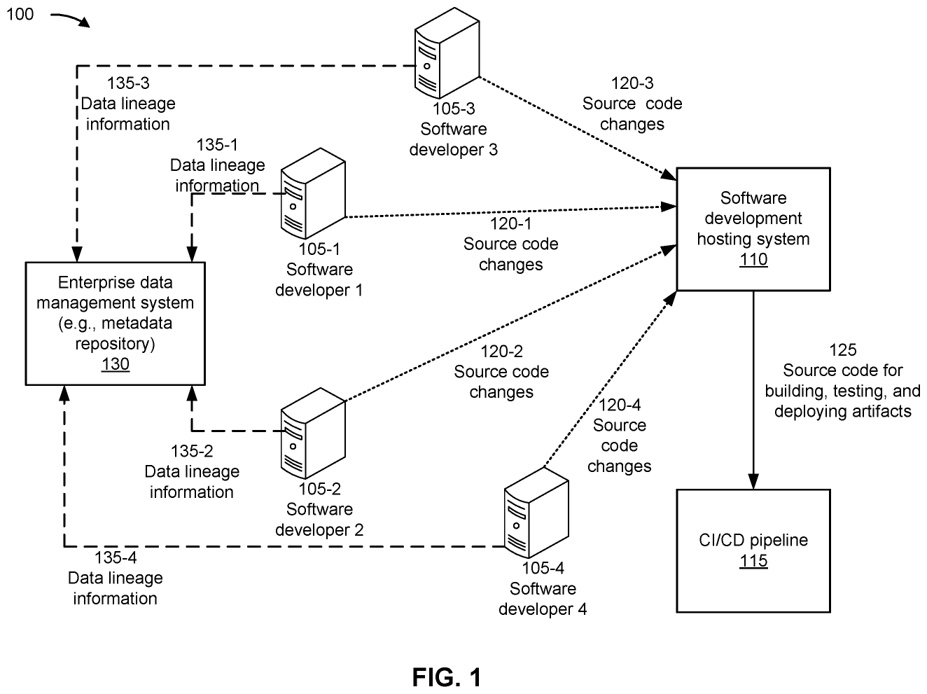

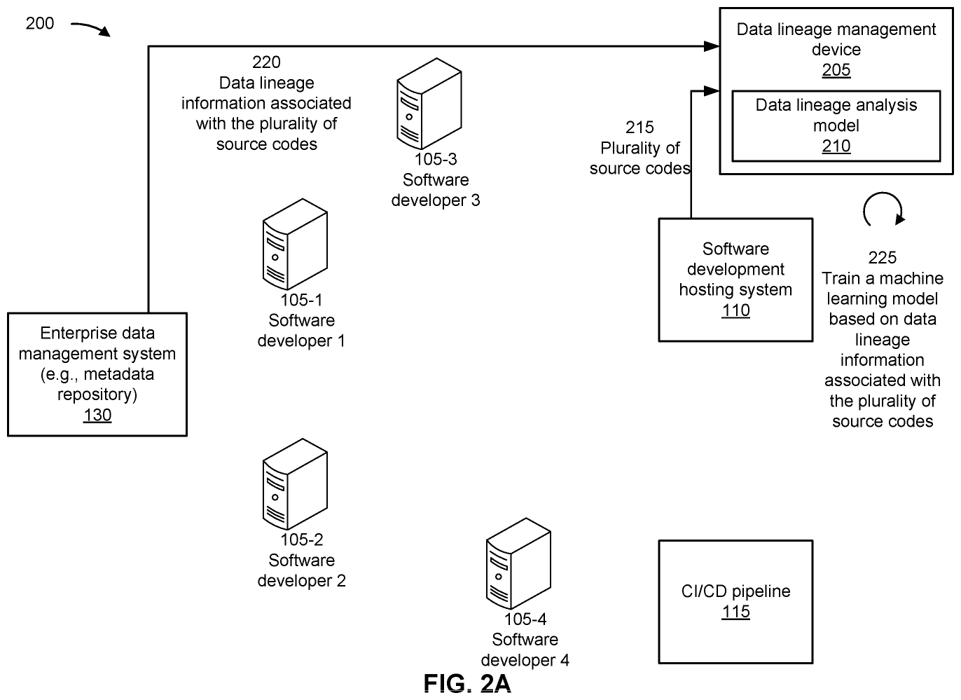

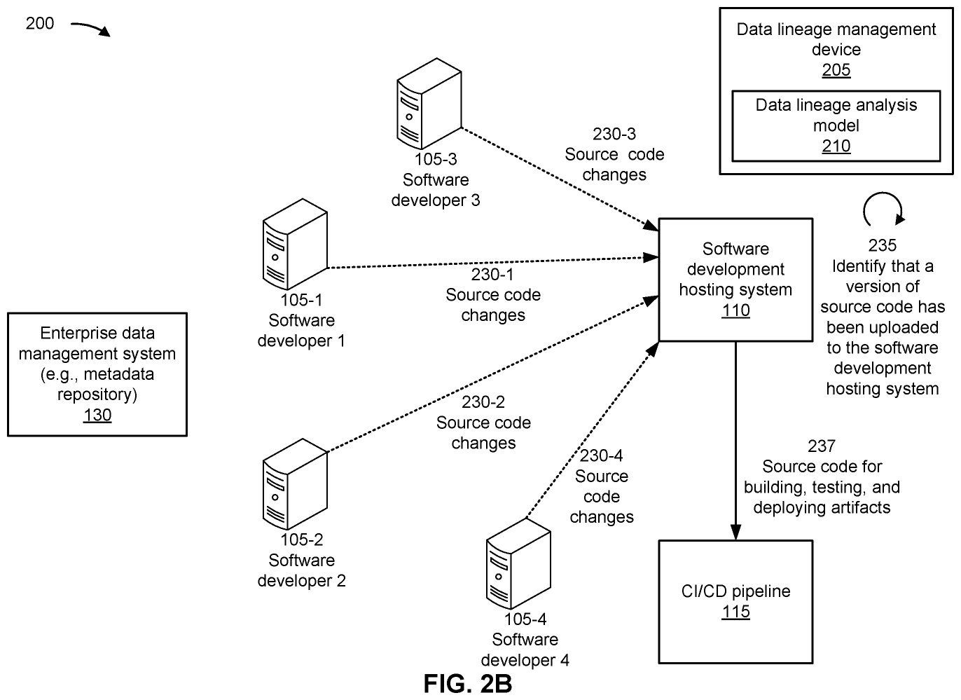

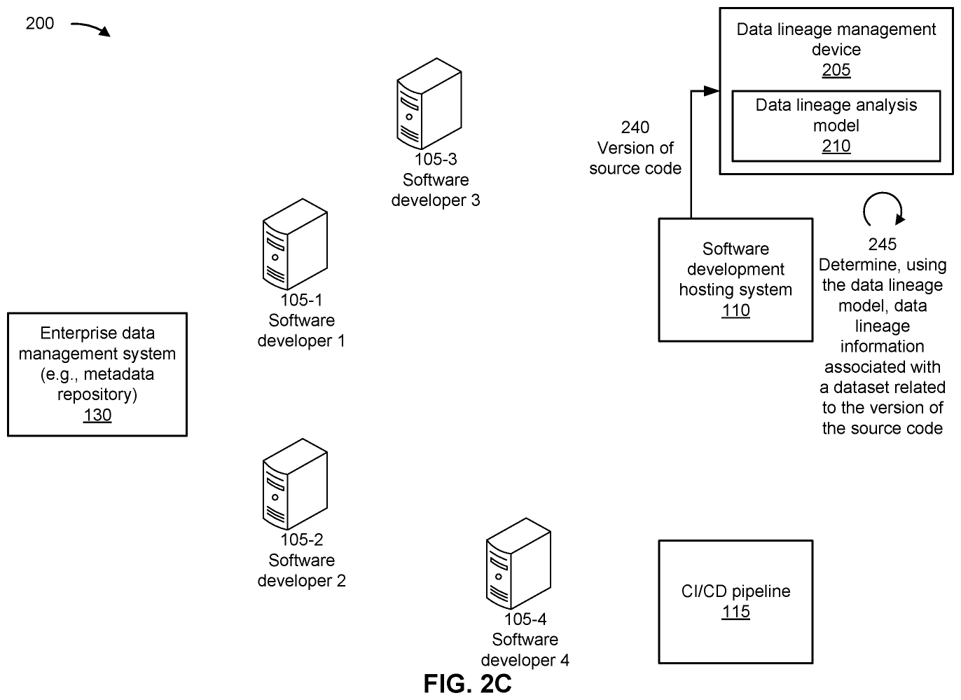

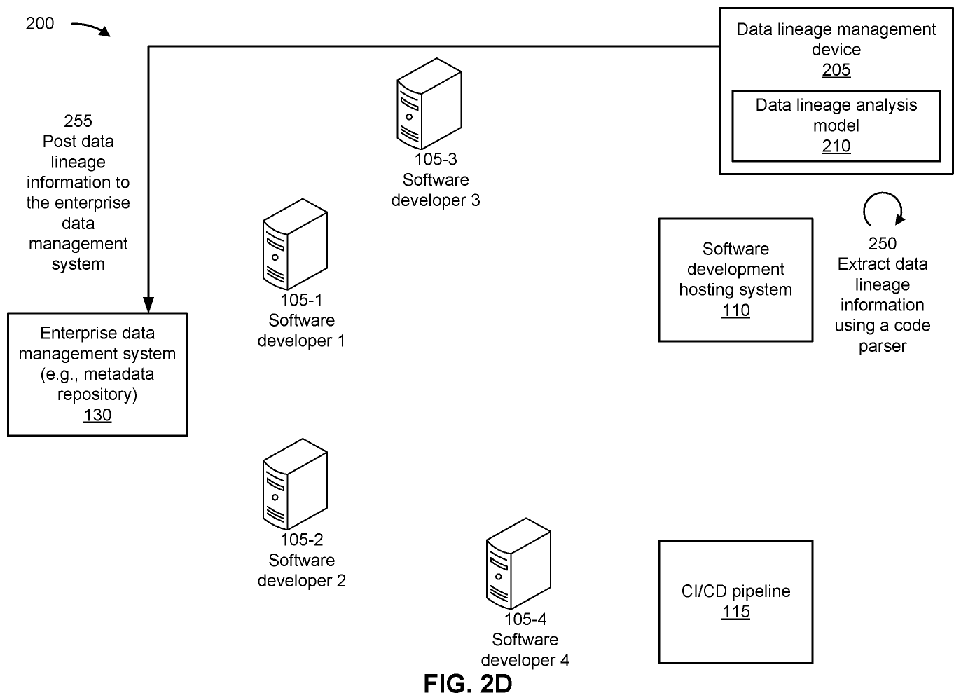

FIG. 1 is a diagram of an example 100 associated with identifying and recording data lineage information. As shown in FIG. 1, example 100 includes multiple software developer devices 105 (shown as software developer device 105-1 through software developer device 105-4 in FIG. 1), a software development hosting system device 110, a continuous improvement/continuous development (CI/CD) pipeline device 115, and an enterprise data management system device 130. These devices are described in more detail in connection with FIGS. 2A-5.

As various software developers make changes to a source code associated with a software project, the software developers may post the source code to a software developer hosting system (e.g., a Git repository hosting service, such as GitHub or a similar service) in order to provide version control and/or otherwise integrate the changes into the software project. For example, when a software developer associated with the first software developer device 105-1 makes changes to a source code associated with a software project, the first software developer device 105-1 may transmit the source code changes to the software development hosting system device 110, as indicated by reference number 120-1. For example, the first software developer device 105-1 may be associated with a Git plugin or a similar application configured to transmit the source code to the software development hosting system device 110 for a purpose of performing version control and/or integrating the changes into a CI/CD pipeline, or the like. Similarly, when software developers associated with the second through fourth software developer devices 105-2 through 105-4 make changes to the source code associated with a software project, the second through fourth software developer devices 105-2 through 105-4 may transmit the source code changes to the software development hosting system device 110, as indicated by reference number 120-2 through 120-4.

In this way, the software development hosting system may integrate source code changes from multiple sources and integrate the changes into a CI/CD pipeline, or the like. For example, as indicated by reference number 125, the software development hosting system device 110 may transmit the source code changes to the CI/CD pipeline device 115 for artifact building, artifact testing, artifact deployment, and/or other CI/CD processes. For example, the CI/CD pipeline device 115 may be associated with a webhook configured to retrieve source code changes from the software development hosting system device 110 upon detecting that updated software code has been posted to the software development hosting system.

Moreover, for compliance purposes, enterprise data management purposes, and/or similar purposes, the software developers may capture data lineage information associated with the source code change and/or push the data lineage information to an enterprise data management system, a metadata repository, and/or a similar system. For example, upon pushing the source code changes indicated by reference number 120-1 to the software development hosting system, the first software developer may manually capture data lineage information associated with the source change and/or may manually post the data lineage information to the enterprise data management system, as indicated by reference number 135-1. Similarly, upon pushing the source code changes indicated by reference numbers 120-2 through 120-4 to the software development hosting system, the second through fourth software developers may manually capture data lineage information associated with the source changes and/or may manually post the data lineage information to the enterprise data management system device 130, as indicated by reference numbers 135-2 through 135-4. Manually capturing and transmitting the data lineage information in this manner may be time-consuming, may require high computational resource usage, may result in disparate forms of data lineage information, and/or may result in incompatible data and high computing resource consumption and high delay resulting from separate handling of the data using complex instructions and/or repetitive processing.

As indicated above, FIG. 1 is provided as an example. Other examples may differ from what is described with regard to FIG. 1.

FIGS. 2A-2D are diagrams of an example 200 associated with a data lineage management system. As shown in FIGS. 2A-2D, example 200 includes the multiple software developer devices 105, the software development hosting system device 110, the CI/CD pipeline device 115, and the enterprise data management system device 130 described above in connection with FIG. 1. Example 200 also includes a data lineage management device 205, which may include, or which may otherwise be associated with, a data lineage analysis model 210. As described in more detail below, the data lineage management device 205 and/or the data lineage analysis model 210 may enable automatic collection and posting of data lineage information associated with source code changes posted to a software development hosting system, thereby enabling the data lineage management system to perform operations based on otherwise incompatible data while conserving computing resources and reducing delays that would otherwise result from separate handling of the data using complex instructions and/or repetitive processing.

As shown in FIG. 2A, the data lineage analysis model may be associated with a machine learning model that is trained based on a plurality of source codes and/or a plurality of data lineage information associated with the plurality of source codes. For example, as indicated by reference number 215, the data lineage management device 205 may retrieve, from a software development hosting system device 110 (e.g., a device associated with a Git repository hosting service, such as GitHub, or a device associated with a similar software development service), a plurality of versions of source codes. In some implementations, the plurality of versions of source codes may include various versions of source code associated with a software project. In that regard, the various versions of source codes may be associated with data lineage information that describes the data lineage of datasets associated with the source codes (e.g., that describes origins of datasets associated with the various versions of source code, processing performed on the datasets, where the datasets moved, and/or the like). Accordingly, in some implementations, the data lineage management device 205 may retrieve the data lineage information associated with the plurality of source codes. For example, as indicated by reference number 220, the data lineage management device 205 may retrieve, from the enterprise data management system device 130, data lineage information associated with the plurality of source codes retrieved from the software development hosting system device 110.

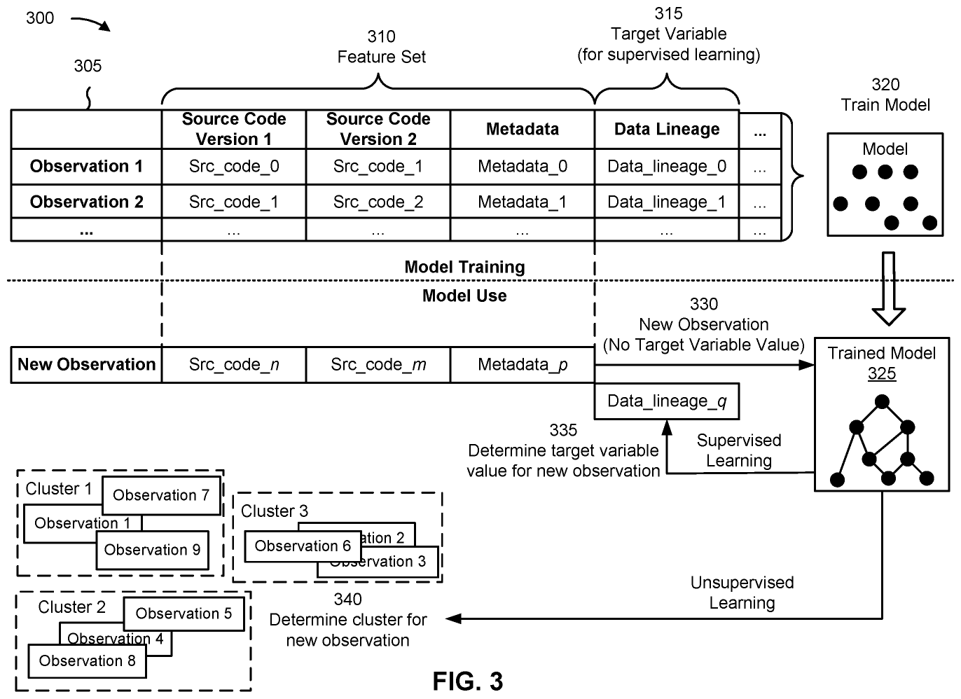

In some implementations, the data lineage analysis model 210 may include a machine learning model, and thus, as indicated by reference number 225, the data lineage management device 205 and/or the data lineage analysis model 210 may train the machine learning model based on the respective data lineage information of the datasets associated with the plurality of source codes. More particularly, the machine learning model may be trained to predict data lineage information for a dataset corresponding to various source code changes, or the like. Aspects of training a machine learning machine learning model based on the respective data lineage information of the datasets associated with the plurality of source codes are described in more detail below in connection with FIG. 3.

As shown in FIG. 2B, and as indicated by reference number 230, as one or more software developers make changes to source code associated with a software project or the like, the software developers may post the updated source code to a source code development hosting system (e.g., a Git repository hosting service, such as GitHub, or a similar service), such as for a purpose of injecting the source code changes into a CI/CD pipeline. For example, when a software developer associated with the first software developer device 105-1 makes changes to a source code associated with a software project, the first software developer device 105-1 may transmit the source code changes to the software development hosting system device 110, as indicated by reference number 230-1. In that regard, the first software developer device 105-1 may be associated with a Git plugin or similar application that pushes the source code changes to the software development hosting system device 110 for a purpose of performing version control and/or integrating the changes into a CI/CD pipeline, or the like. Similarly, when software developers associated with the second through fourth software developer devices 105-2 through 105-4 make changes to the source code associated with a software project, the second through fourth software developer devices 105-2 through 105-4 may transmit the source code changes to the software development hosting system device 110, as indicated by reference number 230-2 through 230-4.

As indicated by reference number 235, the data lineage management device 205 may identify that software code changes have been submitted to the software development hosting system (e.g., the data lineage management device 205 may identify that a version of a certain source code has been uploaded to the software development hosting system device 110, such as for a purpose of integrating the source code changes into the CI/CD pipeline). In some aspects, the data lineage management device 205 may identify that the version of the source code has been uploaded to the software development hosting system device 110 using a data lineage webhook. A webhook is a hypertext transfer protocol (HTTP) based callback function that enables event-driven communication between two devices, such as between two application programming interfaces (APIs). In some aspects, the software development hosting system device 110 may be associated with a data lineage webhook that instructs the software development hosting system device 110 to transmit information to the data lineage management device 205 when a version of source code is received by the software development hosting system device 110 from one or more software developer devices 105. For example, each time source code changes are posted to the software development hosting system, the software development hosting system device 110 may be instructed to transmit, to the data lineage management device 205, an indication that an updated version of source code has been posted to the software development hosting system and/or the updated version of source code itself.

In some implementations, based on receiving the updated source code from one or more software developers, the software development hosting system device 110 may transmit the updated source code to other devices, such as to the CI/CD pipeline device 115 and/or other devices associated with a CI/CD process. For example, as indicated by reference number 237, upon receiving the source code changes from the one or more software developer devices 105, the software development hosting system device 110 may transmit the source code changes to the CI/CD pipeline device 115, such as for a purpose of building, testing, and deploying artifacts associated with the source code changes. Additionally, or alternatively, the software development hosting system device 110 may be associated with a CI/CD webhook (e.g., a webhook associated with a CI/CD pipeline, such as a Jenkins pipeline or a similar CI/CD pipeline) that instructs the software development hosting system device 110 to transmit, to the CI/CD pipeline device 115, an updated version of source code each time changes are posted to the software development hosting system.

As shown in FIG. 2C, and as indicated by reference number 240, the data lineage management device 205 may retrieve a version of source code from the software development hosting system device 110 (e.g., a version of source code associated with the source code changes provided by one or more software developer devices 105). In some implementations, such as implementations in which the software development hosting system device 110 is associated with a data lineage webhook, the software development hosting system device 110 may automatically transmit the version of the source code to the data lineage management device 205 when updated versions of the source code are posted to the software development hosting system. In some other implementations, the software development hosting system device 110 may transmit the version of the source code to the data lineage management device 205 based on receiving a request from the data lineage management device 205. For example, based on identifying that source code changes have been posted to the software development hosting system, the data lineage management device 205 may transmit, to the software development hosting system device 110, a request for an updated version of the source code, and the software development hosting system device 110 may transmit the updated version of the source code to the data lineage management device 205 based on the request.

As indicated by reference number 245, upon receiving the version of the source code, the data lineage management device 205 may determine, using the data lineage analysis model 210, data lineage information associated with a dataset related to the version of the source code received from the software development hosting system device 110. As described above in connection with FIG. 2A, in some implementations the data lineage analysis model 210 may be associated with the machine learning model. Accordingly, in some implementations, the data lineage management device 205 may determine the data lineage information associated with a dataset related to the version of the source code using a machine learning model that is trained based on respective data lineage information of datasets associated with a plurality of source codes, as described above in connection with FIG. 2A.

In some implementations, determining the data lineage information may be based on comparing multiple versions of source code and/or determining information that describes a change to a dataset associated with the multiple versions of the source code. In such implementations, the data lineage management device 205 may retrieve a prior version of the source code from the software development hosting system device 110, and thus may determine the data lineage information associated with the dataset based on the version of the source code and the prior version of the source code. Additionally, or alternatively, in some implementations, the data lineage management device 205 may have a capability of extracting the data lineage information using a code parser. Accordingly, as shown in FIG. 2D, and as indicated by reference number 250, in some implementations the data lineage management device 205 may extract the data lineage information using a code parser.

Moreover, as indicated by reference number 255 in FIG. 2D, the data lineage management device 205 may post the data lineage information to an enterprise data management system (e.g., a metadata repository). More particularly, the data lineage management device 205 may transmit, to the enterprise data management system device 130, the data lineage information associated with the version of the source code received from the software development hosting system device 110. In this way, the data lineage management device 205 and/or the data lineage analysis model 210 may reduce or eliminate the need for each individual software developer to manually determine data lineage information associated with each source code update and/or manually post the data lineage information to an enterprise data management system. Automatically capturing and posting the data lineage information in this manner (e.g., via use of the data lineage management device 205, the data lineage analysis model 210, and/or a machine learning model) is less time-consuming than manually capturing and posting data lineage information, may result in relatively low computational resource usage as compared to manually capturing and posting data lineage information, may result in more uniform data lineage information as compared to manually capturing and posting data lineage information, and/or may result in more compatible data lineage information as compared to manually capturing and posting data lineage information, and thus may result in reduced computing resource consumption and/or reduced delay resulting from separate handling of the data using complex instructions and/or repetitive processing.

As indicated above, FIGS. 2A-2D are provided as an example. Other examples may differ from what is described with regard to FIGS. 2A-2D.

FIG. 3 is a diagram illustrating an example 300 of training and using a machine learning model in connection with data lineage management. The machine learning model training and usage described herein may be performed using a machine learning system. The machine learning system may include or may be included in a computing device, a server, a cloud computing environment, or the like, such as the data lineage management system described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from a software development hosting system (e.g., a Git repository hosting service, such as GitHub or a similar service), an enterprise data management system, a metadata repository, and/or a similar system, as described elsewhere herein.

As shown by reference number 310, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a software development hosting system (e.g., a Git repository hosting service), an enterprise data management system, a metadata repository, and/or a similar system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a first source code version (shown as “Source Code Version 1” in FIG. 3), a second feature of a second source code version (shown as “Source Code Version 2” in FIG. 3), a third feature of metadata associated with the source code, and so on. In some examples, the first source code version and the second source code version may refer to different versions of a same source code. For example, the second source code version may be an updated version of the first source code version, such as a version of the source code following reprogramming by a software developer to remove bugs from the source code, or the like. The metadata may be any type of metadata (e.g., descriptive, administrative, and/or structural metadata) related to the first source code version and/or the second source code version, such as data indicating a user that updated the first source code version to the second source code version, a timestamp indicating when any updates were made, or the like. As shown, for a first observation, the first feature may have a value of Src_code_0, the second feature may have a value of Src_code_1, the third feature may have a value of Metadata_0, and so on.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is data lineage information, which has a value of Data_lineage_0 for the first observation. For example, Data_lineage_0 may correspond to data lineage information manually captured and uploaded to an enterprise data management system, such as by a software developer who updated the source code from Src_code_0 to Src_code_1.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on retrieving various versions of source code from the software development hosting system device 110, as well as associated data lineage information from the enterprise data management system device 130, as described above in connection with reference numbers 215 and 220 in FIG. 2A. The machine learning system may be trained based on the various versions of source code and the associated data lineage information, such as by being trained to determine which types of source code changes require updates to the data lineage information and the specific language required in the data lineage information corresponding to any source code changes that are logged in the data lineage information. For example, if a software developer merely adds a comment to the source code but otherwise does not alter an algorithm associated with the source code, the change may not need to be logged in the enterprise data management system or else may be logged in a first way in the enterprise data management system. On the other hand, if a software developer makes substantive changes to a source code, such as by altering an algorithm associated with the source code, the change may be logged in a second way in the enterprise data management system and/or may be extensively documented in the data lineage information. In this way, the machine learning system may be trained to determine when a change to source code requires an update to associated data lineage information and/or the machine learning system may be trained to determine the corresponding data lineage information.

As shown by reference number 330, the machine learning system may apply the trained machine learning model 325 to a new observation, such as by receiving a new observation and inputting the new observation to the trained machine learning model 325. As shown, the new observation may include a first feature of Src_code_n, a second feature of Src_code_m, a third feature of Metadata_p, and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of Data_lineage_p for the target variable of data lineage information for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that changes to data lineage information associated with the source code be updated to document the change in the source code from Src_code_n to Src_code_m. The first automated action may include, for example, posting updated data lineage information (e.g., Data_lineage_q) to an enterprise data management system.

As another example, if the machine learning system were to predict that no data lineage information needs to be logged for the change to the source code, then the machine learning system may provide a second (e.g., different) recommendation (e.g., that no changes are necessary to data lineage information associated with the source code) and/or may perform or cause performance of a second (e.g., different) automated action (e.g., refraining from posting updated data lineage information (e.g., Data_lineage_q) to an enterprise data management system).

In some implementations, the trained machine learning model 325 may classify (e.g., cluster) the new observation in a cluster, as shown by reference number 340. The observations within a cluster may have a threshold degree of similarity. As an example, if the machine learning system classifies the new observation in a first cluster (e.g., detected substantive changes to a source code algorithm), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., no detected substantive changes to a source code algorithm), then the machine learning system may provide a second recommendation, such as the second recommendation described above. Additionally, or alternatively, the machine learning system may perform a second automated action and/or may cause a second automated action to be performed (e.g., by instructing another device to perform the automated action) based on classifying the new observation in the second cluster, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include updated data lineage information that is posted to the enterprise data management system (e.g., Data_lineage_q) and associated feature sets (e.g., Src_code_n, Src_code_m, and Metadata_p).

In this way, the machine learning system may apply a rigorous and automated process to manage data lineage associated with changes to source code. The machine learning system may enable recognition and/or identification of tens, hundreds, thousands, or millions of features and/or feature values for tens, hundreds, thousands, or millions of observations, thereby increasing accuracy and consistency and reducing delay associated with managing data lineage associated with changes to source code relative to requiring computing resources to be allocated for tens, hundreds, or thousands of operators to manually identify and log data lineage information using the features or feature values.

As indicated above, FIG. 3 is provided as an example. Other examples may differ from what is described in connection with FIG. 3.

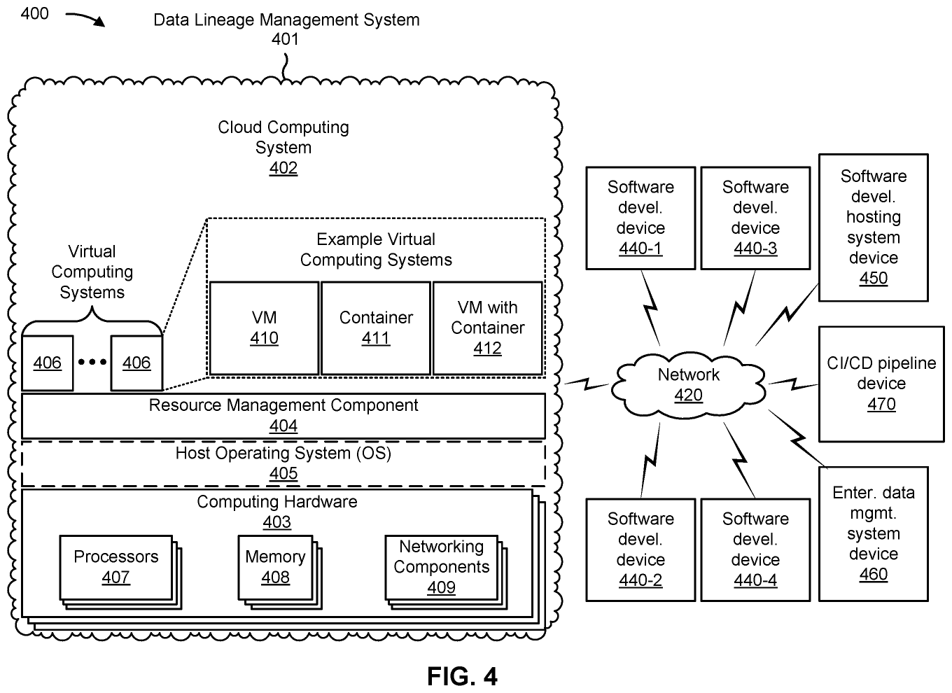

FIG. 4 is a diagram of an example environment 400 in which systems and/or methods described herein may be implemented. As shown in FIG. 4, environment 400 may include a data lineage management system 401, which may include one or more elements of and/or may execute within a cloud computing system 402. The cloud computing system 402 may include one or more elements 403-412, as described in more detail below. As further shown in FIG. 4, environment 400 may include a network 420, one or more software development devices 440 (shown in FIG. 4 as software development device 440-1 through software development device 440-4), a software development hosting system device 450, an enterprise data management system device 460, and/or a CI/CD pipeline device 470. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services system, a Microsoft Azure system, or a Snowflake system. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

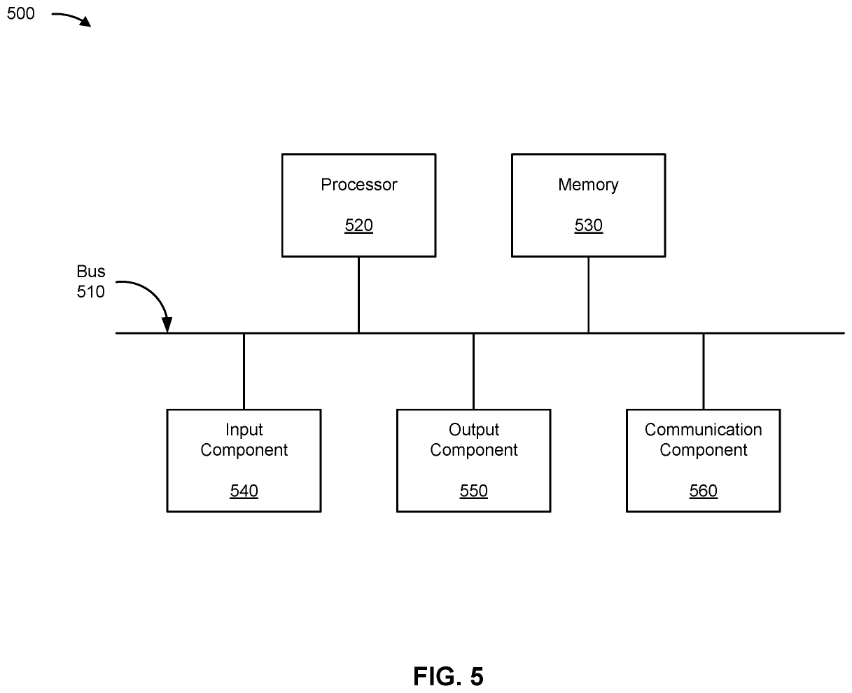

Although the data lineage management system 401 may include one or more elements 403-412 of the cloud computing system 402, may execute within the cloud computing system 402, and/or may be hosted within the cloud computing system 402, in some implementations, the data lineage management system 401 may not be cloud-based (e.g., may be implemented outside of a cloud computing system) or may be partially cloud-based. For example, the data lineage management system 401 may include one or more devices that are not part of the cloud computing system 402, such as device 500 of FIG. 5, which may include a standalone server or another type of computing device. The data lineage management system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The software development device 440 may include a device associated with a software developer and/or a software development team. In some implementations, the software development device 440 may include a client device or similar device capable of running one or more software development programs, such as one or more programs capable of generating source code based on changes to an algorithm made by a software developer. In some implementations, the software development device 440 may be associated with Git, a Git repository hosting service (e.g., GitHub or a similar service), and/or a CI/CD pipeline. For example, the software development device 440 may be associated with a plugin or similar application capable of pushing source code to a Git repository hosting service and/or a CI/CD pipeline.

The software development hosting system device 450 may include a device associated with hosting source code and/or source code changes during a software development process. In some implementations, the software development hosting system device 450 may be associated with a Git repository hosting service (e.g., GitHub or a similar service). The software development hosting system device 450 may be associated with a CI/CD pipeline and/or the CI/CD pipeline device 470. For example, the software development hosting system device 450 may be associated with a webhook (e.g., a Jenkins webhook) that forwards source code to the CI/CD pipeline device 470 when changes to the source code are posted to the software development hosting system device 450. In some implementations, the software development hosting system device 450 may provide version control associated with a software project's code, such as by providing branching and/or merging services for editing a software project's code. In some implementations, the software development hosting system device 450 may be associated with an open-source version control system, such as Git or a similar distributed version control system.

The enterprise data management system device 460 may include a device capable of storing and/or managing enterprise data. In some implementations, the enterprise data management system device 460 may be associated with a metadata repository. Additionally, or alternatively, the enterprise data management system device 460 may be capable of storing and/or displaying data lineage information, such as data lineage information associated with a dataset associated with a source code, or the like.

The CI/CD pipeline device 470 may include a device associated with a CI/CD pipeline (e.g., a Jenkins pipeline or a similar pipeline). In some implementations, the CI/CD pipeline device 470 may be associated with the software development hosting system device 450 and/or may be capable of receiving versions of source code from the software development hosting system device 450. For example, in some implementations the CI/CD pipeline device 470 may be capable of receiving updated source code from the software development hosting system device 450 and testing the updated source code, such as by building artifacts, testing artifacts, and/or deploying artifacts. In some implementations, the CI/CD pipeline device 470 may be associated with a suite of plugins used to move a software project from version control to end users.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with data lineage management. The device 500 may correspond to the data lineage management device 205 and/or a device associated with the data lineage management system 401, the software development device 440, the software development hosting system device 450, the enterprise data management system device 460, and/or the CI/CD pipeline device 470. In some implementations, the data lineage management device 205 and/or a device associated with the data lineage management system 401, the software development device 440, the software development hosting system device 450, the enterprise data management system device 460, and/or the CI/CD pipeline device 470 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

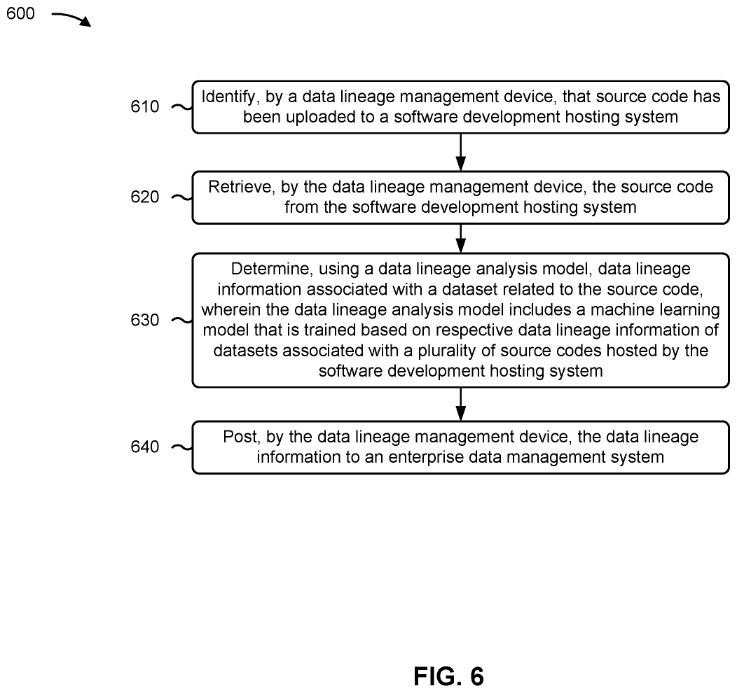

FIG. 6 is a flowchart of an example process 600 associated with data lineage management. In some implementations, one or more process blocks of FIG. 6 may be performed by the data lineage management device 205 and/or the data lineage management system 401. In some implementations, one or more process blocks of FIG. 6 may be performed by another device or a group of devices separate from or including the data lineage management device 205 and/or the data lineage management system 401, such as one or more software development devices 440, the software development hosting system device 450, the enterprise data management system device 460, and/or the CI/CD pipeline device 470. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include identifying that a source code has been uploaded to a software development hosting system (e.g., a Git repository hosting service) (block 610). For example, the data lineage management device 205 and/or the data lineage management system 401 (e.g., using processor 520 and/or memory 530) may identify that a source code has been uploaded to a software development hosting system, as described above in connection with reference number 235 of FIG. 2B. As an example, the data lineage management device 205 and/or the data lineage management system 401 may be associated with a data lineage webhook or similar webhook, such that, when a software developer posts updated code to the software development hosting system, the data lineage management device 205 and/or the data lineage management system 401 may automatically retrieve the new version of the source code from the software development hosting system.

As further shown in FIG. 6, process 600 may include retrieving the source code from the software development hosting system (block 620). For example, the data lineage management device 205 and/or the data lineage management system 401 (e.g., using processor 520 and/or memory 530) may retrieve the source code from the software development hosting system, as described above in connection with reference number 240 of FIG. 2C. As an example, the data lineage management device 205 and/or the data lineage management system 401 may retrieve the source code from the software development hosting system using the data lineage webhook described above in connection with block 610.

As further shown in FIG. 6, process 600 may include determining, using a data lineage analysis model, data lineage information associated with a dataset related to the source code, wherein the data lineage analysis model includes a machine learning model that is trained based on respective data lineage information of datasets associated with a plurality of source codes (block 630). For example, the data lineage management device 205 and/or the data lineage management system 401 (e.g., using processor 520 and/or memory 530) may determine, using a data lineage analysis model (e.g., data lineage analysis model 210), data lineage information associated with a dataset related to the source code, wherein the data lineage analysis model includes a machine learning model that is trained based on respective data lineage information of datasets associated with a plurality of source codes, as described above in connection with reference number 245 of FIG. 2C. As an example, after retrieving a new version of source code from the software development hosting system (e.g., a Git repository hosting service) via the data lineage webhook, the data lineage management device 205 and/or the data lineage management system 401 may identify whether changes to the source code necessitate updates to the data lineage information and, if so, may determine updated data lineage information to be posted to an enterprise data management system, such as by using the trained machine learning model (which may be trained in a manner similar to that described above in connection with FIG. 3).

As further shown in FIG. 6, process 600 may include posting the data lineage information to an enterprise data management system (block 640). For example, the data lineage management device 205 and/or the data lineage management system 401 (e.g., using processor 520 and/or memory 530) may post the data lineage information to an enterprise data management system (e.g., enterprise data management system device 130), as described above in connection with reference number 255 of FIG. 2D. As an example, for source code changes that require data lineage information updates, the data lineage management device 205 and/or the data lineage management system 401 may post the updated data lineage information to the enterprise data management system, which may thus be accessed and/or viewed by users seeking to understand a version history and/or audit trail of a dataset associated with the source code.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 2A-3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for managing data lineage, the system comprising:
one or more memories; and
one or more processors, communicatively coupled to the one or more memories, configured to:
identify that a version of a source code has been uploaded to a software development hosting system device;
retrieve the version of the source code from the software development hosting system device;
determine, using a data lineage analysis model, data lineage information associated with a dataset related to the version of the source code, wherein the data lineage analysis model includes a machine learning model that is trained based on respective data lineage information of datasets associated with a plurality of source codes; and
post the data lineage information to an enterprise data management system.

2. The system of claim 1, wherein, to identify that the version of the source code has been uploaded to the software development hosting system device, the one or more processors are configured to identify that the version of the source code has been uploaded to the software development hosting system device using a data lineage webhook.

3. The system of claim 1, wherein the software development hosting system device is associated with a Git repository hosting service.

4. The system of claim 1, wherein the enterprise data management system is associated with a metadata repository.

5. The system of claim 1, wherein, to determine the data lineage information, the one or more processors are further configured to extract the data lineage information using a code parser.

6. The system of claim 1, wherein the one or more processors are further configured to train the machine learning model based on the respective data lineage information of the datasets associated with the plurality of source codes.

7. The system of claim 1, wherein the one or more processors are further configured to retrieve a prior version of the source code from the software development hosting system device, and
wherein, to determine the data lineage information associated with the dataset, the one or more processors are configured to determine the data lineage information associated with the dataset based on the version of the source code and the prior version of the source code.

8. A method for managing a data lineage of a dataset, comprising:
identifying, by a data lineage management device, that a source code has been uploaded to a Git repository hosting service;
retrieving, by the data lineage management device, the source code from the Git repository hosting service;
determining, using a data lineage analysis model, data lineage information associated with a dataset related to the source code, wherein the data lineage analysis model includes a machine learning model that is trained based on respective data lineage information of datasets associated with a plurality of source codes; and
posting, by the data lineage management device, the data lineage information to an enterprise data management system.

9. The method of claim 8, wherein identifying that the source code has been uploaded to the Git repository hosting service is performed using a data lineage webhook.

10. The method of claim 8, further comprising retrieving a prior version of the source code from the Git repository hosting service,
wherein determining the data lineage information associated with the dataset is based on the source code and the prior version of the source code.

11. The method of claim 8, wherein the enterprise data management system is associated with a metadata repository.

12. The method of claim 8, wherein determining the data lineage information includes extracting the data lineage information using a code parser.

13. The method of claim 8, further comprising training the machine learning model based on the respective data lineage information of the datasets associated with the plurality of source codes.

14. A non-transitory computer-readable medium storing a set of instructions, the set of instructions comprising:
one or more instructions that, when executed by one or more processors of a data lineage management device, cause the data lineage management device to:
train a machine learning model based on respective data lineage information of datasets associated with a plurality of source codes;
identify that a version of a source code has been uploaded to a software development hosting system device;
retrieve the version of the source code from the software development hosting system device; and
determine, using a data lineage analysis model, data lineage information associated with a dataset related to the version of the source code, wherein the data lineage analysis model includes the machine learning model.

15. The non-transitory computer-readable medium of claim 14, wherein the one or more instructions further cause the data lineage management device to post the data lineage information to an enterprise data management system.

16. The non-transitory computer-readable medium of claim 15, wherein the enterprise data management system is associated with a metadata repository.

17. The non-transitory computer-readable medium of claim 14, wherein the one or more instructions, that cause the data lineage management device to identify that the version of the source code has been uploaded to the software development hosting system device, cause the data lineage management device to identify that the version of the source code has been uploaded to the software development hosting system device using a data lineage webhook.

18. The non-transitory computer-readable medium of claim 14, wherein the software development hosting system device is associated with a Git repository hosting service.

19. The non-transitory computer-readable medium of claim 14, wherein the one or more instructions, that cause the data lineage management device to determine the data lineage information, cause the data lineage management device to extract the data lineage information using a code parser.

20. The non-transitory computer-readable medium of claim 14, wherein the one or more instructions further cause the data lineage management device to retrieve a prior version of the source code from the software development hosting system device, and
wherein the one or more instructions, that cause the data lineage management device to determine the data lineage information associated with the dataset, cause the data lineage management device to determine the data lineage information associated with the dataset based on the version of the source code and the prior version of the source code.
